(19) United States
(12) Patent Application Publication
(10) Pub. No.: US 2016/0292967 A1
(43) Pub. Date: Oct. 6, 2016

(54) Method and Device for Payment Processing

(71) Applicant: ZTE Corporation, Shenzhen (CN)

(72) Inventor: Xi CHEN, Shenzhen (CN)

(21) Appl. No.: 15/103,982

(22) PCT Filed: May 28, 2014
(86) PCT No.: PCT/CN2014/078691

§ 371 Date: Jun. 13, 2016

(30) Foreign Application Priority Data
Dec. 13, 2013 (CN) 201310687022.5

(51) Int. Cl. G07F 17/32; G06Q 20/32; G06Q 20/40

(52) U.S. Cl. CPC G07F 17/3244; G06Q 20/40; G06Q 20/322; G07F 17/3223

(57) ABSTRACT

A method and device for payment processing, wherein the method includes that a background platform running independent of a service receives payment information corresponding to the service; and the background platform conducts payment corresponding to the service according to the payment information, wherein both the reception of the payment information and the conduction of the payment are executed in parallel to operation of the service, thus solving problems caused by that it is necessary to interrupt operation of a service when continuous operation of the service needs to be paid during the operation of the service, and the operation of the service may be resumed only after the payment is successful, i.e. only a single-thread payment method can be used in the related art. Therefore, the service operating currently is not interrupted by operation of the payment, so as to ensure continuous operation of the service, and improve user experience.

### TECHNICAL FIELD

The disclosure relates to the Internet field, and in particular to a method and device for payment processing.

### BACKGROUND

Mobile phone gaming services are relatively sophisticated solutions for implementing added value services of a mobile Internet system, and most mobile phone gaming services need to be paid online. There are many online payment methods, including Alipay, Shenzhoufu, Unionpay and so on. However, these payment methods are operated in a single thread manner when a user experiences a game, and a game may be resumed only after being paid successfully, thus consuming a lot of time and affecting experience. On the other hand, the user needs to input related private information of the user during the payment, which also undermines information security of the user. Therefore, a game operator needs to start considering solutions for problems including information security of a game user and a usability perceived by the user, while the problems are caused by the single thread operation.

At present, no reasonable solution has been provided yet to solve the problems caused by that it is necessary to interrupt operation of a service when continuous operation of the service needs to be paid during the operation of the service, and the operation of the service may be resumed only after the payment is successful, i.e. only a single-thread payment method can be used in the related art.

### SUMMARY

The embodiments of disclosure provide a method and device for payment processing, so as to solve the problems caused by that it is necessary to interrupt operation of a service when continuous operation of the service needs to be paid during the operation of the service, i.e. only a single-thread payment method can be used in the related art.

A method for payment processing is provided according to an embodiment of the disclosure, including that:

receiving, by a background platform running independent of a service, payment information corresponding to the service; and conducting, by the background platform, payment corresponding to the service according to the payment information, wherein both the reception of the payment information and the conduction of the payment are executed in parallel to operation of the service.

In an example embodiment, receiving, by the background platform, the payment information corresponding to the service includes: receiving a text message, wherein the text message carries the payment information; and conducting, by the background platform, the payment corresponding to the service according to the payment information includes: extracting the payment information from the text message, and conducting the payment corresponding to the service according to the payment information.

In an example embodiment, conducting, by the background platform, the payment corresponding to the service according to the payment information includes: acquiring a user Identifier (ID) of a terminal from which the payment information is sent, or a user ID of a terminal carried in the payment information; and deducting an amount of money corresponding to the payment information from an account corresponding to the user ID, to complete the payment corresponding to the service.

In an example embodiment, deducting the amount of money corresponding to the payment information from the account corresponding to the user ID, to complete the payment corresponding to the service includes: judging whether or not a total amount of payment of the account in a preset period of time exceeds a threshold, and when the total amount of payment of the account in the preset period of time does not exceed the threshold, deducting the amount of money corresponding to the payment information, to complete the payment corresponding to the service.

In an example embodiment, the method further includes: in a case that the total amount of payment of the account in the preset period of time exceeds the threshold, terminating the payment and prompting a user corresponding to the user ID.

In an example embodiment, deducting the amount of money corresponding to the payment information from the account corresponding to the user ID, to complete the payment corresponding to the service includes: judging whether or not the user ID is in a white list; and in a case that the user ID is not in the white list, deducting the account of money corresponding to the payment information from the account corresponding to the user ID, to complete the payment corresponding to the service; while in a case that the user ID is in the white list, not deducting the account of money corresponding to the payment information.

In an example embodiment, deducting the amount of money corresponding to the payment information from the account corresponding to the user ID, to complete the payment corresponding to the service includes: in a case that a balance of the account is smaller than the amount of money, performing recording; and after the account is recharged, performing the deduction, to complete the payment corresponding to the service.

In an example embodiment, receiving the payment information corresponding to the service includes: receiving the payment information encrypted by a preset encryption algorithm.

A device for payment processing is further provided according to another embodiment of the disclosure, including:

a receiving component, configured to receive payment information corresponding to the service; and a processing component, configured to conduct payment corresponding to the service according to the payment information, wherein both the reception of the payment information and the conduction of the payment are executed in parallel to operation of the service.

In an example embodiment, the device includes: the receiving component, configured to receive a text message, wherein the text message carries the payment information; and the processing component configured to conduct the payment corresponding to the service according to the payment information by the following steps: extracting the payment information from the text message, and conduct the payment corresponding to the service according to the payment information.

In an example embodiment, the processing component includes: an acquiring element, configured to acquire a user Identifier (ID) of a terminal from which the payment information is sent, or a user ID of a terminal carried in the payment information; and a payment element, configured to deduct an amount of money corresponding to the payment information from an account corresponding to the user ID, to complete the payment corresponding to the service.

In an example embodiment, the payment element is configured to judge whether or not a total amount of payment of the account in a preset period of time exceeds a threshold, and when the total amount of payment of the account in the preset period of time does not exceed the threshold, deduct the amount of money corresponding to the payment information, so as to complete the payment corresponding to the service.

In an example embodiment, the processing component further includes: a prompting element configured to, in a case that the total amount of payment of the account in the preset period of time exceeds the threshold, terminate the payment and prompt a user corresponding to the user ID.

In an example embodiment, the payment element is configured to judge whether or not the user ID is in a white list; and in a case that the user ID is not in the white list, deduct the account of money corresponding to the payment information from the account corresponding to the user ID, to complete the payment corresponding to the service; while in a case that the user ID is in the white list, not deduct the account of money corresponding to the payment information.

In an example embodiment, the payment element is configured to, in a case that a balance of the account is smaller than the amount of money, perform recording; and after the account is recharged, perform the deduction, to complete the payment corresponding to the service.

In an example embodiment, the receiving component is configured to receive the payment information encrypted by a preset encryption algorithm.

According to the embodiments of the disclosure, a background platform running independent of a service receives payment information corresponding to the service; and the background platform conducts payment corresponding to the service according to the payment information, wherein both the reception of the payment information and the conduction of the payment are executed in parallel to operation of the service, so that the service operating currently is not interrupted by operation of the payment, thus solving problems caused by that it is necessary to interrupt operation of a service when continuous operation of the service needs to be paid during the operation of the service, and the operation of the service may be resumed only after the payment is successful, i.e. only a single-thread payment method can be used in the related art.

### BRIEF DESCRIPTION OF THE DRAWINGS

The accompanying drawings described herein are used for providing further understanding to the disclosure and form a part of the present application. The schematic embodiments of the disclosure and description of the schematic embodiments are used for explaining the disclosure, instead of forming improper limitation thereto. In the accompanying drawings:

FIG. 1 is a flowchart of a method for payment processing according to an embodiment of the disclosure;

FIG. 2 is a block diagram of a device for payment processing according to an embodiment of the disclosure;

FIG. 3 is a block diagram of a device for payment processing according to a first example embodiment of the disclosure;

FIG. 4 is a block diagram of a device for payment processing according to a second example embodiment of the disclosure; and

FIG. 5 is a networking structural diagram of a charging system according to an embodiment of the disclosure.

### DETAILED DESCRIPTION

It needs to be noted that the embodiments in the present application and the characteristics in the embodiments may be combined with each other if there is no conflict. The disclosure will be expounded hereinafter with reference to the accompanying drawings and in combination with the embodiments.

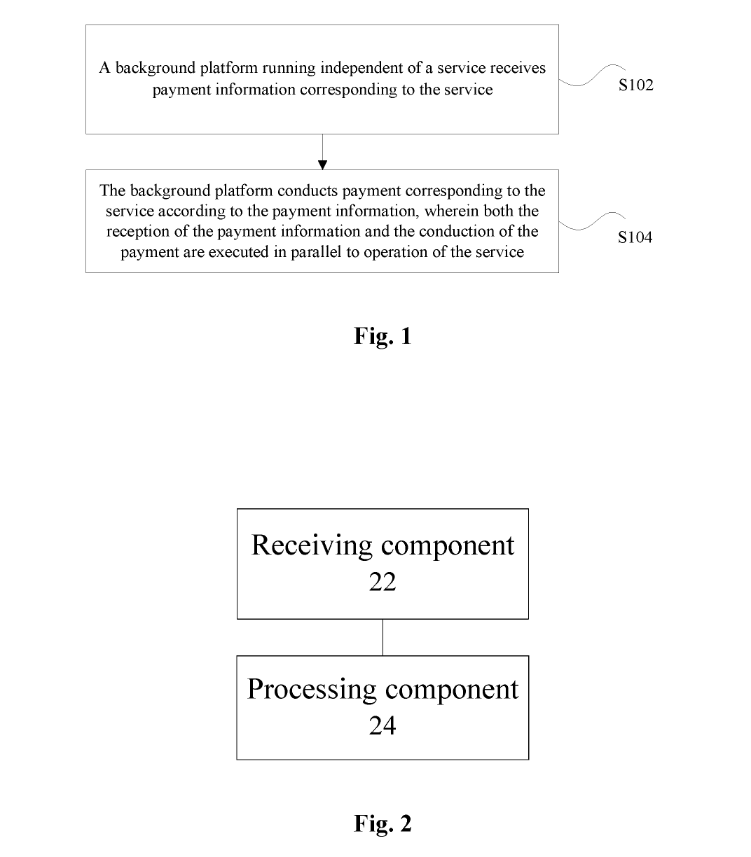

A method for payment processing is provided in the present embodiment. FIG. 1 is a flowchart of a method for payment processing according to an embodiment of the disclosure. As shown in FIG. 1, the flow includes the following steps.

Step 102: A background platform running independent of a service receives payment information corresponding to the service.

Step 104: The background platform conducts payment corresponding to the service according to the payment information, wherein both the reception of the payment information and the conduction of the payment are executed in parallel to operation of the service.

By means of the steps above, if a terminal needs to pay for continuing operation of a service during an operation process of the service, a background platform receives the payment information, corresponding to the service, from the terminal, and parses the payment information to conduct the payment so that the service may continue operating. In the meanwhile, the operation of the service is not interrupted by operation of a payment function. In other words, the background platform receives the payment information and conducts the payment in parallel to the operation of the service. Compared with a method in the related art that a service operates in a single thread manner, it is necessary to interrupt the operation of the service when continuous operation of the service needs to be paid during the operation of the service, and the operation of the service may be resumed only after the payment is successful, the embodiment of the disclosure, by means of the steps above, allows the background platform to receive the payment information of the terminal, so as to complete the payment in parallel with the service operating currently without affecting the currently-operating service that is operated by a user continuously and improving user experience.

In an example embodiment, a text message may be encrypted by a preset encryption algorithm, such as a Triple Data Encryption Algorithm (3DES) encryption algorithm, and then the payment corresponding to the service is completed according to the payment information, so that the payment information is safer.

The payment information may be sent by many methods. In an example embodiment, the payment information may be sent by a text message. Step 102 may include that: a text message is received, wherein the text message carries the payment information; and Step 104 may include that: the payment information is extracted from the text message, and the payment corresponding to the service is conducted according to the payment information. It is more convenient to send the payment information through the text message, which may be implemented by a device of an existing network side. For example, in a case that the service is a game, an uplink text message instruction may be sent to a text message gateway through an embedded Software Development Kit (SDK) of the game during a gaming process of the user, the background platform parses and records a content of the text message, and then a timing task interface scans the content of the text message, so as to finally complete a charging operation from a user number to a Value Added Carrier (VAC) side and prompt the user.

There may be many payment methods. For example, the payment may be implemented by a third party payment function. In an example embodiment, the payment may be also implemented by directly deducting money from an account associated with a user ID. For example, the payment is performed by mobile phone bill payment of the user. In other words, in the example embodiment, a user ID of a terminal, from which the payment information is sent, is acquired, and an amount of money corresponding to the payment information is deducted from an account corresponding to the user ID, so as to complete the payment corresponding to the service. Or, as another example embodiment, a user ID of a terminal may be also carried in the payment information, and an amount of money corresponding to the payment information is deducted from an account corresponding to the user ID, so as to complete the payment corresponding to the service.

In an example embodiment, for example, whether or not a total amount of payment of the account in a preset period of time exceeds a threshold may be judged when the amount of money is deducted from the account corresponding to the user ID, and if the total amount of payment of the account in the preset period of time exceeds the threshold, the amount of money corresponding to the payment information is deducted, so as to complete the payment corresponding to the service, thereby preventing a user complaint due to deduction of a large amount of money caused by misoperation of the game user. For example, maximum amounts of daily expense and monthly expense of text message withholding of a single mobile phone are limited, and the limitation may be configured by the background platform. Furthermore, in a case that the total amount of payment of the account in the preset period of time exceeds the threshold, the payment is terminated and the user corresponding to the user ID is prompted. For example, when the daily expense or the monthly expense of the user exceeds the limitation of the maximum amount, the user will not be charged continuously, and the user will be prompted friendly.

In an example embodiment, a white list may be further set, and a user in the white list does not need to pay. In other words, whether or not the user ID is in a white list may be judged when the amount of money is deducted from the account corresponding to the user ID; and in a case that the user ID is not in the white list, the account of money corresponding to the payment information is deducted from the account corresponding to the user ID, so as to complete the payment corresponding to the service; and in a case that the user ID is in the white list, the account of money corresponding to the payment information is not deducted.

In an example embodiment, in a case that a balance of the account is smaller than the amount of money, recording may be also performed; and after the account is recharged, the deduction is performed, so as to complete the payment corresponding to the service.

A device for payment processing is further provided in the present embodiment. The device is configured to implement the method above, and what has been described in the method above will not be repeated here. The names of components in the device below should not be understood as limitation to the components. For example, a receiving component, configured to receive payment information corresponding to the service, may be also described as “a component configured to receive payment information corresponding to the service”. Functions of the components described below may be implemented by a processor. FIG. 2 is a block diagram of a device for payment processing according to an embodiment of the disclosure. As shown in FIG. 2, the device includes: a receiving component 22 and a processing component 24.

The receiving component 22 is configured to receive payment information corresponding to the service; and the processing component 24 is configured to conduct payment corresponding to the service according to the payment information, wherein both the reception of the payment information and the conduction of the payment are executed in parallel to operation of the service.

In an example embodiment, the receiving component 22 is configured to receive a text message, wherein the text message carries the payment information; and the processing component 24 is configured to conduct the payment corresponding to the service according to the payment information by the following steps: extracting the payment information from the text message, and conducting the payment corresponding to the service according to the payment information.

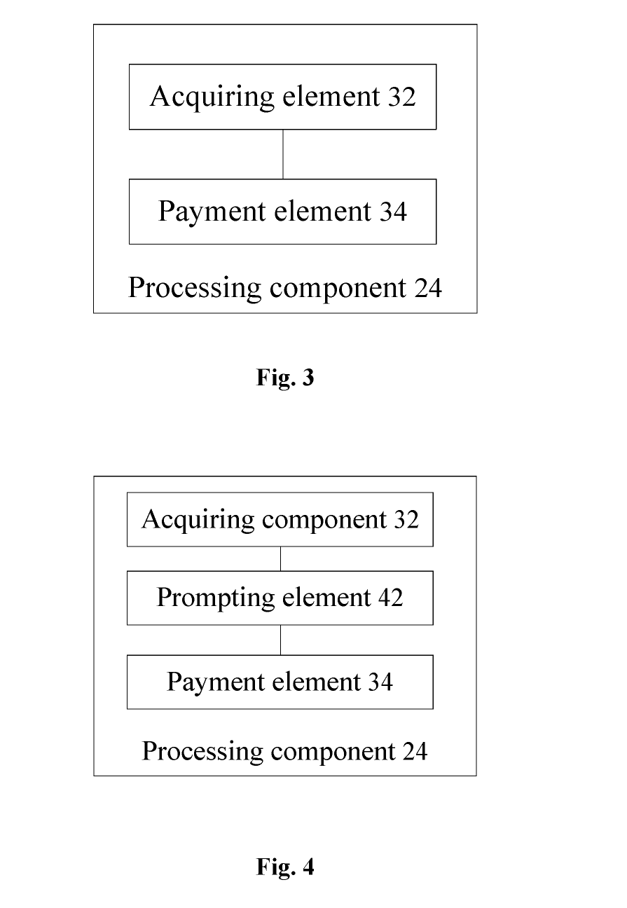

FIG. 3 is a block diagram of a device for payment processing according to a first example embodiment of the disclosure. As shown in FIG. 3, the processing component 24 includes: an acquiring element 32, configured to acquire a user ID of a terminal from which the payment information is sent, or a user ID of a terminal carried in the payment information; and a payment element 34, configured to deduct an amount of money corresponding to the payment information from an account corresponding to the user ID, so as to complete the payment corresponding to the service.

In an example embodiment, the payment element 34 is configured to judge whether or not the total amount of payment of the account in a preset period of time exceeds a threshold, and if the total amount of payment of the account in the preset period of time exceeds the threshold, deduct the amount of money corresponding to the payment information, so as to complete the payment corresponding to the service.

FIG. 4 is a block diagram of a device for payment processing according to a second example embodiment of the disclosure. As shown in FIG. 4, the processing component 24 further includes: a prompting element 42 configured to, in a case that the total amount of payment of the account in the preset period of time exceeds the threshold, terminate the payment and prompt a user corresponding to the user ID.

In an example embodiment, the payment element 34 is configured to judge whether or not the user ID is in a white list; and in a case that the user ID is not in the white list, deduct the account of money corresponding to the payment information from the account corresponding to the user ID, so as to complete the payment corresponding to the service; and in a case that the user ID is in the white list, not deduct the account of money corresponding to the payment information.

In an example embodiment, the payment element 34 is configured to, in a case that a balance of the account is smaller than the amount of money, perform recording; and after the account is recharged, perform the deduction, so as to complete the payment corresponding to the service.

In an example embodiment, the receiving component 22 is configured to receive the payment information encrypted by a preset encryption algorithm.

Description will be provided below in combination with an example embodiment.

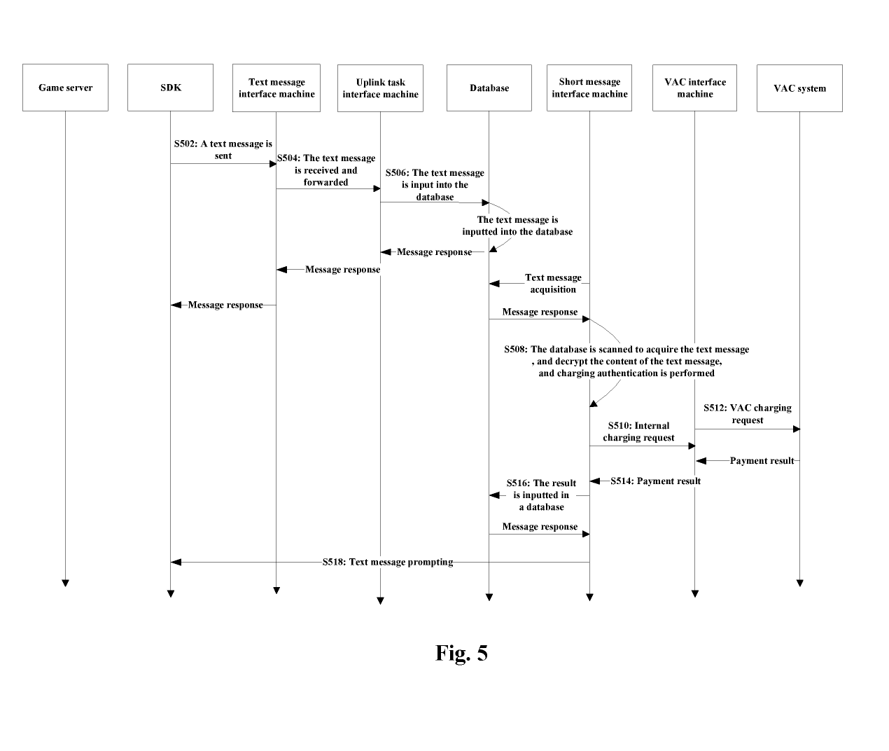

A system is provided in the present example embodiment. The system may include several components as follows: a game embedded SDK, a text message interface machine, an uplink task interface machine, a service database, a text message withholding interface machine, a vac charging interface machine, and a vac system, as shown in FIG. 5, wherein the text message machine is configured to connect a text message gateway, and the text message gateway forwards a text message whose target number is a sp number to the text message interface machine. Functions of the receiving component 22 and the processing component 24 are conducted by at least one of the text message interface machine, the uplink task interface machine, the service database, the text message withholding interface machine, the vac charging interface machine and the vac system.

A method for implementing text message withholding in a game service in the present example embodiment may include the following steps.

Step 1: After a user acknowledges payment, the game embedded SDK sends an uplink text message to the text message gateway. Besides, a 3DES encryption algorithm is applied to a content of an uplink instruction of the text message in the embodiment of the disclosure so as to ensure the safety of network communication.

Step 2: The text message gateway receives the text message, and forwards the text message whose target number is a sp number to the text message interface machine.

Step 3: The text message interface machine receives the text message from the text message gateway, and forwards the text message to the uplink task interface machine.

Step 4: The uplink task interface machine saves a user number and the content of the text message to a task list and waits for processing of a timing task.

Step 5: The text message withholding task interface machine periodically scans records to be processed in the task list of a database, and reads and parses the records to be processed to acquir the content of the text message, and authenticates the content of the text message, including a user, a developer, a channel and a charging point.

Step 6: After successful authentication, information including the user number, the charging point and so on is used as parameters to invoke an internal charging interface, i.e. the vac interface machine.

Step 7: The vac interface machine initiates a charging request to a vac system, receives a charging result from the vac system and notifies the text message withholding task interface machine of a payment result.

Step 8: The text message withholding task interface machine saves a user payment record for a subsequent query of a user and a manager.

Step 9: After a charging action is completely, a message is sent to prompt the uplink number.

Gaming and payment are operated in parallel through the steps above, and the user only needs to acknowledge payment so as to continue the gaming, while a subsequent charging action is completed by the charging system on the background platform. A complicated charging flow is avoided for the user, thereby greatly improving gaming experience of the user.

In an example embodiment, when an amount of money is deducted from an account corresponding to a user ID, whether or not the total amount of payment of the account in a preset period of time exceeds a threshold may be also judged, and if the total amount of payment of the account in the preset period of time does not exceed the threshold, the amount of money corresponding to payment information is deducted, so as to complete the payment corresponding to the service. For example, the maximum amounts of daily expense and monthly expense of text message withholding of a single mobile phone are limited, and the limitation may be configured by the background platform, thereby preventing a user complaint due to deduction of a large amount of money caused by misoperation of the game user. When the daily expense or the monthly expense of the user exceeds the limitation of the maximum amount, the user will not be charged continuously, and the user will be prompted friendly.

In an example embodiment, in a case that the total amount of the payment of the account in the preset period of time exceeds the threshold, the payment is terminated, and the user corresponding to the user ID is prompted.

In an example embodiment, the present system also maintains a user white list at the same time, a user in the white list may be queried in the background platform, and operations including addition, deletion, modification and query may be performed. Text message withholding requests from numbers of these users will not be subjected to charging processing.

In an example embodiment, when an abnormality occurs during the payment process, such as insufficient balance, a supplementary phone bill charging flow may be also supported. Those records of payment failures caused by abnormal reasons are founded among payment records, and payment requests are further sent to the vac payment system.

Description will be provided with reference to FIG. 5 below.

Step 502: When a user clicks to acknowledge purchase of an item, the embedded SDK will be invoked to send an uplink text message. An uplink instruction includes the following information: a purchase type (a mission, an item and so on), a Cross-Project ID (CPID, namely an ID of an developer with VAC qualification), a service code (a unique VAC charging code corresponding to a type of a purchased service in short) and a channel code (a game promotion channel). After encrypting the information, the SDK sends the text message to the text message gateway.

Step 504: After receiving the text message, the text message gateway forwards the text message whose target number is a sp number to the text message interface machine, and the text message interface machine forwards the text message to the uplink task interface machine.

Step 506: After receiving the text message, the uplink task interface machine inputs a content of the text message and a user number to a task list of a database and the task list mainly saves all uplink charging requests.

Step 508: The text message withholding interface machine periodically scans records to be paid in the database, decrypts the content of the text message by using a decryption algorithm, and performs charging authentication on the request.

The present system is able to set a type of a charging point. When the user purchases a mission type charging point, repeated purchase will not be charged any more, while it is necessary to charge a consumable charging point.

During the authentication, it is necessary to authenticate a current daily expense and monthly expense of the user, and charging will not be performed if the current daily expense and monthly expense are beyond the authentication, thereby avoiding a deduction of a large amount of money due to misoperation of the user and a resulting user complaint.

Step 510: After successful authentication, an internal charging request is sent to the vac charging interface machine.

Step 512: The internal charging interface, i.e. the vac charging interface machine sends a charging request to the vac system by using information including the user number and a charging price point and so on as parameters.

Step 514: The vac system notifies the text message withholding interface machine of a payment result after successful charging.

Step 516: The text message withholding interface machine saves a user payment record in a database so that the user payment record can be queried by the user and a manager subsequently.

Step 518: After a text message withholding operation succeeds, a text message will be sent to prompt the uplink mobile phone number of the user.

Different text message templates are set for different service types in the embodiment of the disclosure, thus the content of a text message is determined by a service type, so as to provide a friendlier interface to a user.

By means of the example embodiments above, payment may be performed on a background platform simultaneously in a case that the payment is acknowledged by the user during a gaming process, thus greatly improving user experience.

Obviously, those skilled in the art should understand that, each component or each step in the disclosure may be implemented by a universal computing device. They may be concentrated on a single computing device or distributed on a network composed of a plurality of computing devices. Optionally, they may be implemented by program codes executable by a computing device so that they may be stored in a storing device and implemented by the computing device, or they may be implemented by respectively fabricating them into each integrated circuit component, or by fabricating a plurality of components or steps of them into a single integrated circuit component. In this way, the disclosure is not limited to any specific combination of software and hardware.

The above are only example embodiments of the disclosure, but are not used for limiting the disclosure. For those skilled in the art, the disclosure may have various alterations and variations. Any modification, equivalent replacement, improvement and so on made within the spirit and principle of the disclosure should be included within the scope of protection of the disclosure.

### INDUSTRIAL APPLICABILITY

The disclosure relates to the Internet field, and provides a method and device for payment processing. In the method for payment processing, a background platform running independent of a service receives payment information corresponding to the service; and the background platform conducts payment corresponding to the service according to the payment information, wherein both the reception of the payment information and the conduction of the payment are executed in parallel to operation of the service. The disclosure solves problems caused by that it is necessary to interrupt operation of a service when continuous operation of the service needs to be paid during the operation of the service, and the operation of the service may be resumed only after the payment is successful, i.e. only a single-thread payment method can be used in the related art. Therefore, the service operating currently is not interrupted by operation of the payment, so as to ensure continuous operation of the service, and improve user experience.

1. A method for payment processing, comprising:
receiving, by a background platform running independent of a service, payment information corresponding to the service; and
conducting, by the background platform, payment corresponding to the service according to the payment information, wherein both the reception of the payment information and the conduction of the payment are executed in parallel to operation of the service.

2. The method as claimed in claim 1, wherein
receiving, by the background platform, the payment information corresponding to the service comprises: receiving a text message, wherein the text message carries the payment information; and
conducting, by the background platform, the payment corresponding to the service according to the payment information comprises: extracting the payment information from the text message, and conducting the payment corresponding to the service according to the payment information.

3. The method as claimed in claim 1, wherein conducting, by the background platform, the payment corresponding to the service according to the payment information comprises:
acquiring a user Identifier (ID) of a terminal from which the payment information is sent, or a user ID of a terminal carried in the payment information; and
deducting an amount of money corresponding to the payment information from an account corresponding to the user ID, to complete the payment corresponding to the service.

4. The method as claimed in claim 3, wherein deducting the amount of money corresponding to the payment information from the account corresponding to the user ID, to complete the payment corresponding to the service comprises:
judging whether or not a total amount of payment of the account in a preset period of time exceeds a threshold, and when the total amount of payment of the account in the preset period of time does not exceed the threshold, deducting the amount of money corresponding to the payment information, to complete the payment corresponding to the service.

5. The method as claimed in claim 4, further comprising:
in a case that the total amount of payment of the account in the preset period of time exceeds the threshold, terminating the payment and prompting a user corresponding to the user ID.

6. The method as claimed in claim 3, wherein deducting the amount of money corresponding to the payment information from the account corresponding to the user ID, to complete the payment corresponding to the service comprises:
judging whether or not the user ID is in a white list; and
in a case that the user ID is not in the white list, deducting the account of money corresponding to the payment information from the account corresponding to the user ID, to complete the payment corresponding to the service; while in a case that the user ID is in the white list, not deducting the account of money corresponding to the payment information.

7. The method as claimed in claim 3, wherein deducting the amount of money corresponding to the payment information from the account corresponding to the user ID, to complete the payment corresponding to the service comprises:
in a case that a balance of the account is smaller than the amount of money, performing recording; and
after the account is recharged, performing the deduction, to complete the payment corresponding to the service.

8. The method as claimed in claim 1, wherein receiving the payment information corresponding to the service comprises:
receiving the payment information encrypted by a preset encryption algorithm.

9. A device for payment processing, comprising:
a receiving component, configured to receive payment information corresponding to the service; and
a processing component, configured to conduct payment corresponding to the service according to the payment information, wherein both the reception of the payment information and the conduction of the payment are executed in parallel to operation of the service.

10. The device as claimed in claim 9, wherein the device comprises:
the receiving component, configured to receive a text message, wherein the text message carries the payment information; and
the processing component configured to conduct the payment corresponding to the service according to the payment information by the following steps: extracting the payment information from the text message, and conduct the payment corresponding to the service according to the payment information.

11. The device as claimed in claim 9, wherein the processing component comprises:
an acquiring element, configured to acquire a user Identifier (ID) of a terminal from which the payment information is sent, or a user ID of a terminal carried in the payment information; and
a payment element, configured to deduct an amount of money corresponding to the payment information from an account corresponding to the user ID, to complete the payment corresponding to the service.

12. The device as claimed in claim 11, wherein the payment element is configured to judge whether or not a total amount of payment of the account in a preset period of time exceeds a threshold, and when the total amount of payment of the account in the preset period of time does not exceed the threshold, deduct the amount of money corresponding to the payment information, so as to complete the payment corresponding to the service.

13. The device as claimed in claim 12, wherein the processing component further comprises:
a prompting element configured to, in a case that the total amount of payment of the account in the preset period of time exceeds the threshold, terminate the payment and prompt a user corresponding to the user ID.

14. The device as claimed in claim 11, wherein the payment element is configured to judge whether or not the user ID is in a white list; and in a case that the user ID is not in the white list, deduct the account of money corresponding to the payment information from the account corresponding to the user ID, to complete the payment corresponding to the service; while in a case that the user ID is in the white list, not deduct the account of money corresponding to the payment information.

15. The device as claimed in claim 11, wherein the payment element is configured to, in a case that a balance of the account is smaller than the amount of money, perform recording; and after the account is recharged, perform the deduction, to complete the payment corresponding to the service.

16. The device as claimed in claim 9, wherein the receiving component is configured to receive the payment information encrypted by a preset encryption algorithm.

17. The method as claimed in claim 2, wherein conducting, by the background platform, the payment corresponding to the service according to the payment information comprises:
acquiring a user Identifier (ID) of a terminal from which the payment information is sent, or a user ID of a terminal carried in the payment information; and
deducting an amount of money corresponding to the payment information from an account corresponding to the user ID, to complete the payment corresponding to the service.

18. The method as claimed in claim 17, wherein deducting the amount of money corresponding to the payment information from the account corresponding to the user ID, to complete the payment corresponding to the service comprises:
judging whether or not a total amount of payment of the account in a preset period of time exceeds a threshold, and when the total amount of payment of the account in the preset period of time does not exceed the threshold, deducting the amount of money corresponding to the payment information, to complete the payment corresponding to the service.

19. The device as claimed in claim 10, wherein the processing component comprises:
an acquiring element, configured to acquire a user Identifier (ID) of a terminal from which the payment information is sent, or a user ID of a terminal carried in the payment information; and
a payment element, configured to deduct an amount of money corresponding to the payment information from an account corresponding to the user ID, to complete the payment corresponding to the service.

20. The device as claimed in claim 19, wherein the payment element is configured to judge whether or not a total amount of payment of the account in a preset period of time exceeds a threshold, and when the total amount of payment of the account in the preset period of time does not exceed the threshold, deduct the amount of money corresponding to the payment information, so as to complete the payment corresponding to the service.
